(19) United States
(12) Patent Application Publication
(10) Pub. No.: US 2008/0062181 A1
(43) Pub. Date: Mar. 13, 2008

(54) Receiving system's display property provided to a sending system

(76) Inventors: Roland M. Hochmuth, Fort Collins, CO (US); James M. King, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/490,976

(22) Filed: Jul. 21, 2006

(51) Int. Cl. G06F 15/00

(52) U.S. Cl. 345/501

(57) ABSTRACT

A method comprises a receiving system receiving display properties of a display coupled to the receiving system. The receiving system is operatively coupled to a sending system. The method further comprises transmitting the display properties to the sending system and informing an operating system running on the sending system of the display properties.

### BACKGROUND

Some electronic systems permit a user of one computer to view on his or her display images (graphics and text) that are generated on another computer remotely located from the user's computer. In some such systems, the remote computer where the graphics data is generated transmits images or commands to the user's computer that causes the users computer to replicate the images on the computer where the images originated. The display attached to the user's computer may have various display properties that can be configured as desired by the user. Unfortunately, the remote computer will not be aware of the properties of the user's display.

### BRIEF DESCRIPTION OF THE DRAWINGS

For a detailed description of exemplary embodiments of the invention, reference will now be made to the accompanying drawings in which:

FIG. 1 shows a system in accordance with various embodiments of the invention comprising a sending system and a receiving system;

FIG. 2 shows an embodiment exemplary of a sending system or a receiving system;

FIG. 3 illustrates a method in accordance with embodiments of the invention; and

FIG. 4 illustrates another method in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

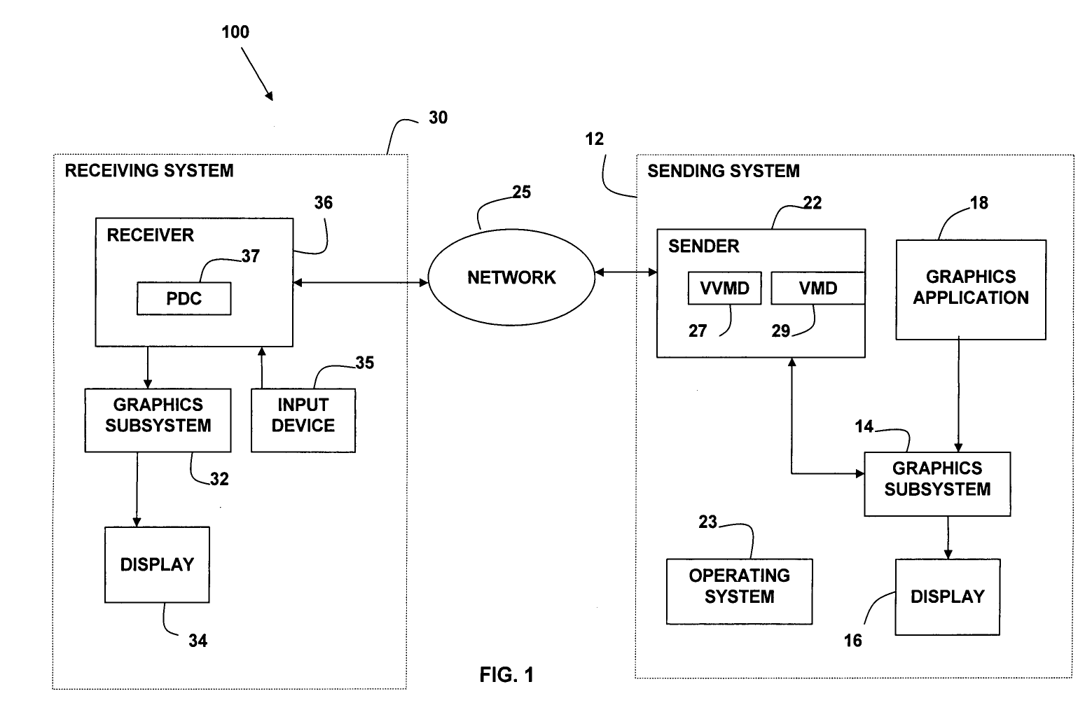

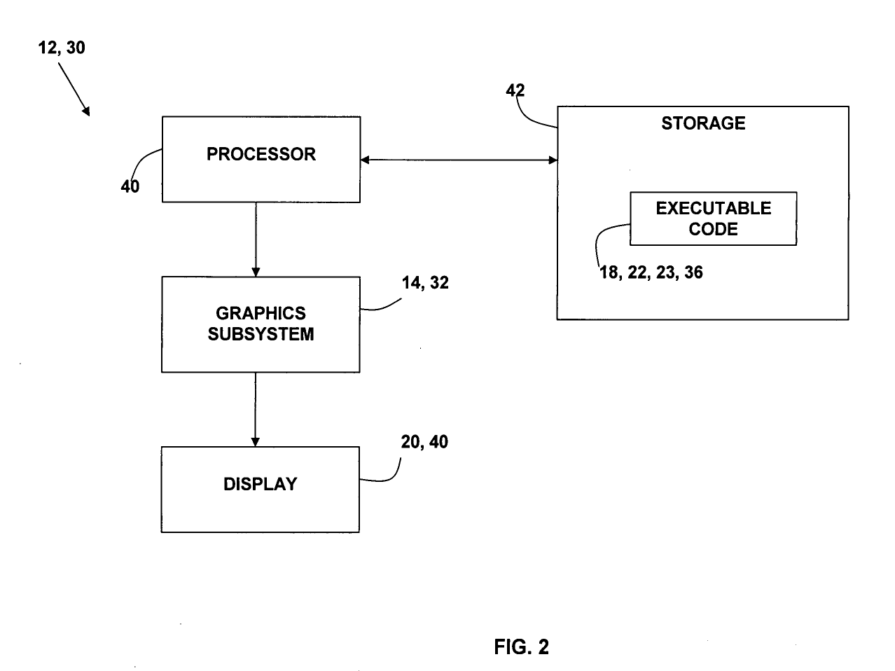

FIG. 1 shows an embodiment comprising a system 100. System 100 comprises a sending system 12 and a receiving system 30 in communication with each other by way of a network 25. Network 25 may comprise the Internet or other form of communication network. Network 25 may include a point-to-point communication link, as well as multi-drop networks as are typical of local area networks. As shown, the sending system 12 comprises a graphics subsystem 14, a display 16, a graphics application 18, a sender 22 and operating system 23. The graphics application 18 and sender 22 comprise executable code. The receiving system 30 comprises a graphics subsystem 32, a display 34, and a receiver 36. The receiver 36 in the receiving system comprises executable code. Referring briefly to FIG. 2 in conjunction with FIG. 1, each of the sending system 12 and receiving system 30 comprises a processor 40, storage 42, and, as noted above, a graphics subsystem 14, 32 and a display 20, 40. Each executable code (i.e., the graphics application 18, the sender 22, the operating system 23, and the receiver 36) in the illustrated embodiment are executed by the respective processor 40 in that system and are stored in storage 42. Storage 42 may comprise volatile storage (e.g., random access memory), non-volatile storage (e.g., hard disk drive) or a combination thereof. Each of the graphics subsystems 14 and 32 may comprise additional executable code such as application programming interfaces (APIs), graphics drivers, one or more hardware components such a graphics adapter, etc. Each graphics subsystem also includes at least one frame buffer into which pixel color values are temporarily stored to render pixels on the associated display.

Referring to FIG. 1, sending system 12 executes a graphics application 18 that causes images (e.g., text, lines, fills) to be shown by the graphics subsystem 14 on the display 16. The graphics application 18 comprises any one or more of a plurality of executable programs that use a graphics API. The APIs used by the graphics application are implemented by the graphics subsystem 14. The graphics application 18 causes images to be shown on display 16 by providing graphics commands to the graphics subsystem 14 which creates and stores images in a frame buffer in the graphics subsystem 14. The sender 22 reads the images from the graphics subsystem's frame buffer and, in at least some embodiments, compresses the images for subsequent transmission to the receiving system 30. Via network 25, the sending system 12 sends the compressed images to the receiving system 30. The receiving system 30 receives the compressed images from the sending system, decompresses the images, and shows the decompressed images on display 34. The process is repetitive as the sending system continues to render new or updated images in its own graphics subsystem 14.

In some embodiments, the sending system 12 has a display 16 coupled thereto, but in other embodiments, the sending system's display 16 is not included. The receiving system 30 may include an input device 35, such as a keyboard or mouse, which permits a user of the receiving system to effectively interact with the graphics application 18 as if the graphics application were being executed on the receiving system 30.

In accordance with various embodiments of the invention, the display 34 of the receiving system 30 has one or more display properties. An example of such a display property is resolution. Another example includes refresh rate. Different types of displays support different settings for such properties. For example, one particular display may support one or more settings of resolution, while another display may support a different, albeit perhaps overlapping, group of settings.

The display 34 is capable of informing the receiving system of the display properties supported by that display. In an illustrative embodiment, such supported display property information is provided by the display to the graphics subsystem in accordance with the Extended Display Identification Data (EDID) standard. The display property information can be requested by the receiving system's processor 40 or is automatically provided upon boot-up of the receiving system or, after boot-up, the display 34 being connected to the receiving system.

Figure still to FIG. 1, the receiver 36 comprises a Physical Display Component (PDC) 37. The sender 22 comprises a Virtual Video Miniport Driver (WVMD) 27 and a Video Miniport Driver (VMD) 29. In at least some embodiments, the PDC 37, VVMD 27, and driver 39 are implemented in software. In general, the PDC 37 is responsible for detecting when a display is coupled to the receiving system and for obtaining the properties of the display. The VMD 29 is present on at least some existing computers and receives requests from the sending system's operating system 23 to show or change display properties associated with the sending system's own graphics subsystem 14. The VMD 29 may perform other functions as well. In accordance with embodiments of the invention, the VVMD 27 emulates at least a portion of the behavior of the VMD 29 and provides at least some of the same software interfaces as the VMD 29. The VVMD 27 manages the display properties associated with a remote system, such as receiving system 30, in a way that is generally transparent to the sending system's operating system 23.

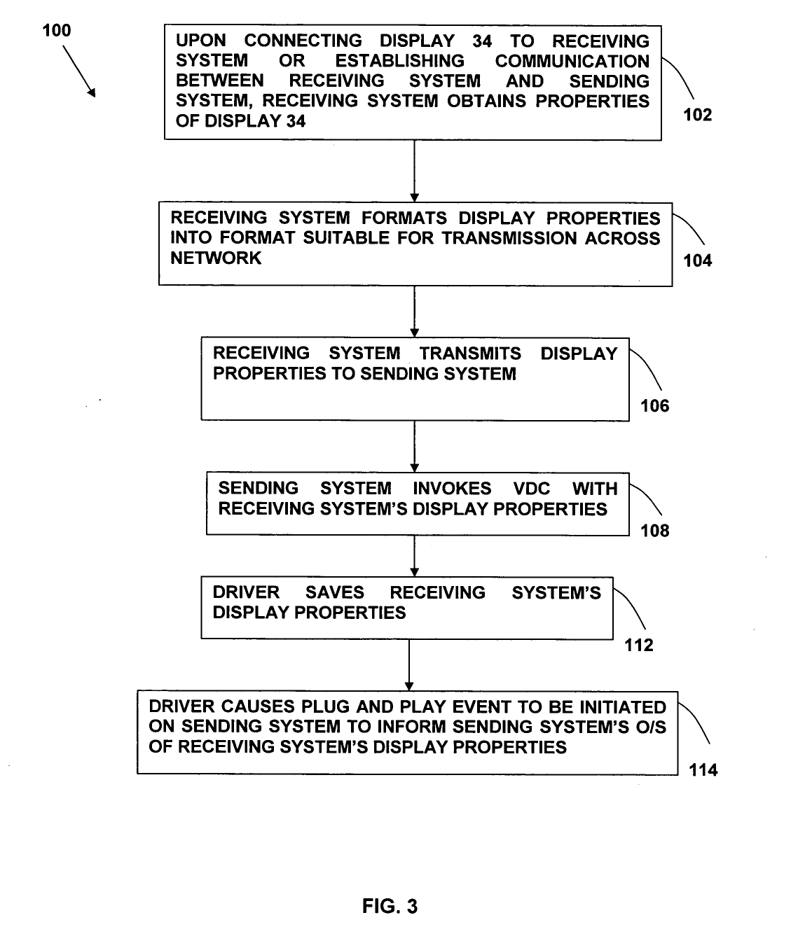

FIG. 3 shows an embodiment of a method 100 whereby the sending system is informed of the display properties of the receiving system's display 34. In block 102, method 100 comprises the receiving system 30 obtaining the display properties of the display 34. This action is performed when, for example, the display 34 is connected to the receiving system 30 or upon establishing communication between the receiving system 30 and the sending system 12.

In block 104, the receiving system 30 formats the display properties into a format suitable for transmission across the network 25 to the sending system. The format naturally varies from implementation to implementation. In some embodiments, a communication packet having a data payload is formed, destined for the sending system 12, and the data payload comprises the display properties. In block 106, the receiving system 30 transmits its display properties to the sending system.

In block 108, the VVMD 27 in the sending system 12 is invoked, as if it were the VMD 29, using the receiving system's display properties received over the network. At 110, the VVMD 27 saves the receiving system's display properties in storage 42 in the sending system (block 112) and then, at block 114 and in accordance with least some embodiments, causes a plug-and-play event to be initiated. The plug-and-play event initiated by driver 29 causes the sending system's operating system 23 to be informed of the receiving system's display properties. The graphics subsystem 14 is configured by the operating system to use the properties (e.g., resolution) of the display 34.

In accordance with at least some embodiments, the VMMD 27 provide a mechanism by which the sending system's operating system 23 is informed of the display properties of the receiving system in a manner that is generally transparent to the operating system. That is, in at least some embodiments, the operating system 23 does not and/or cannot distinguish between display properties that are associated with the display 34 of the remote receiving system 30 versus display 16 that may be locally present on the sending system 12. The operating system 23 interacts with the VVMD 27 as if it were interacting with the VMD 29 to retrieve or store display properties. The VVMD 27 manages the receiving system's display properties and provides such properties to the operating system 23. As noted above, the VMD 29 may perform other functions besides just handling display property-related requests. Such requests from the operating system, as well as display property requests specific to the sending system's own graphics subsystem 14, are not handled by the VVMD 27. Instead, the VVMD 27 forwards such requests to the VMD 29 for processing. As such, the VVMD 27 filters operating system requests. Requests related to the receiving system's display properties are processed by the VVMD 27 itself, while all other requests are forwarded to the VMD for processing. The sending system's operating system need not be modified to implement the functionality described herein.

At some point in time, a user of the receiving system may desire to access the display properties associated with the display 34. The user may desire simply to view the properties, but may also desire to change one or more of the properties. Using the input device 35, the user provides an input to the receiver 36 that signals that the user desires to access the display properties. The user input, for example, may be in the form of a “right click” on a mouse while a cursor is positioned over a “desktop” image on the display 34. Doing so will cause a communication to be sent to the sending system that the user has right clicked on a certain location on the desktop image thereby causing the sending system to initiate a corresponding action. That action may be to cause a menu to shown on the receiving system's display 34 by which the user can select a display property to view and/or change. The menu is generated in the form of an image by the sending system's graphics subsystem 14. The image is read from a frame buffer in the graphics subsystem 14, compressed, and transmitted to the receiving system 30 for display on the receiving system's display 34 as explained previously. The underlying processing pertaining to generating the menu, determining which menu item the user has selected, etc. is performed by the sending system (e.g., by graphics application 18 or operating system 23).

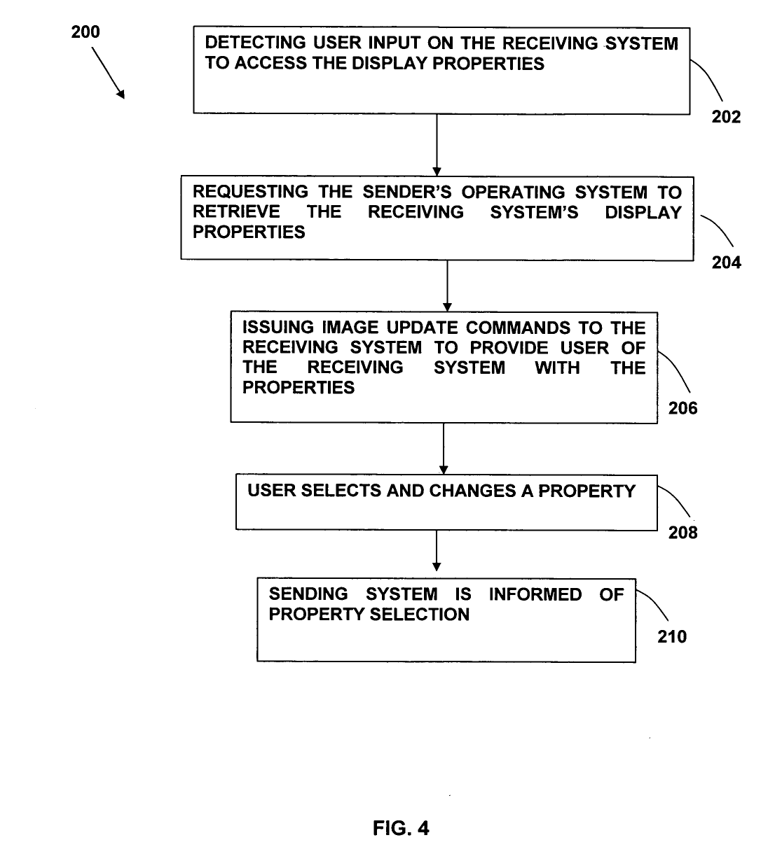

FIG. 4 illustrates an embodiment of another method 200 by which the user, via the receiving system 30, can access the display properties that are stored on the sending system 12. At 202, the method comprises detecting user input on the receiving system. At 204, the sending system's operating system 23 is requested to retrieve the receiving system's display properties that are stored on the sending system's storage 42 and such request is handled by the VVMD 27 as described above. At 206, the sender 22 provides one or more images to the receiving system to provide the user of the receiving system with an indication of the properties. Such images may be in the form of menus or other graphical representations. If the user desires to change a property, the user then selects the desired property to change and changes the property (at 208). At 210, the sending system's operating system 23 is informed of the change in display property. Via the VVMD 27, the operating system 23 configures the graphics subsystem to implement any changes to the display properties (e.g., a change in resolution, refresh rate, etc.).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
a receiving system receiving display properties of a display coupled to the receiving system, said receiving system operatively coupled to a sending system;
transmitting said display properties to the sending system; and
informing an operating system running on the sending system of said display properties.

2. The method of claim 1 further comprising detecting a user input on said receiving system to access said display properties and requesting the sender's operating system to retrieve the receiving system's display properties.

3. The method of claim 2 wherein said receiving system is operatively coupled to said sending system via a network.

4. The method of claim 1 further comprising causing a plug and play event to be initiated on the sending system to thereby inform the operating system of said display properties.

5. The method of claim 1 wherein the receiving system receiving the display properties occurs upon coupling the display to the receiving system or upon operatively coupling the receiving system to the sending system.

6. The method of claim 1 further comprising informing the sending system of a change in a display property selected by a user of the receiving system.

7. The method of claim 1 further comprising the sending system generating image update commands in accordance with the display properties.

8. The method of claim 1 wherein the receiving system receiving display properties of the display comprises the receiving system receiving at least one resolution setting supported by said display.

9. A local system, comprising:
a receiver that receives images from a sending system;
a graphics subsystem that receives information from the receiver as to how to render pixels on a display; and
an input device by which a user requests access to the display property;
wherein said property is stored on said sending system and said display property is provided to the receiver via the network.

10. The local system of claim 9 wherein said display property is shown on a display coupled to said receiver.

11. The local system of claim 9 wherein, via said input device, the user changes said display property.

12. The local system of claim 9 wherein a change in said display property is provided to the sending system.

13. The local system of claim 9 wherein said display property is at least display resolution.

14. A computing system, comprising:
a sender that sends images to a receiving system;
an operating system;
a graphics subsystem operatively coupled to said sender;
wherein said sender receives a property of a display, said display being coupled to said receiving system, and said operating system is informed of said received property.

15. The computing system of claim 14 wherein said sender causes a plug and play event to be initiated to thereby inform the operating system of said received property.

16. The computing system of claim 14 wherein said property is at least a resolution of said display.

17. The computing system of claim 14 wherein said sender provides an image destined for said receiving system that includes said property.

18. The computing system of claim 14 wherein, in response to a user input to said receiving system, said sender provides an image destined for said receiving system that includes said property.

19. The computing system of claim 14 further comprising a virtual driver that emulates a video driver with regard to said display property of said display.
